(19) United States
(12) Patent Application Publication
(10) Pub. No.: US 2004/0008352 A1
(43) Pub. Date: Jan. 15, 2004

(54) Precision size measuring apparatus

(76) Inventors: Satoshi Hirokawa, Kodaira (JP); Shogo Kosuge, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/435,255

(22) Filed: May 12, 2003

(30) Foreign Application Priority Data
May 14, 2002 (JP) 2002-138978

(51) Int. Cl. G01B 11/14

(52) U.S. Cl. 356/625

(57) ABSTRACT

A high precision size measuring apparatus for measuring a degree of alignment accuracy for elements such as semiconductor elements formed on an object to be measured, such as a semiconductor wafer. The apparatus has a holding portion for fixing thereon the object to be measured, a movable bed for moving the object to be measured, for a first optical system for detecting alignment accuracy of a plurality of elements formed on the object to be measured, and a second optical system different from the first optical system, for detecting alignment of the object to be measured which serves as a reference point for alignment accuracy, having dimensions different from that of the plurality of elements.

### CROSS-REFERENCE TO RELATED APPLICATIONS

This invention relates to the following U.S. Patent applications assigned to the same assignee of the present application.

patent application Ser. No. 10/060,321, filed on Feb. 1, 2002, in the names of Tamotsu Tominaga and Satoshi Hirokawa and entitled “POSITION MEASURING APPARATUS”, the disclosure of which is hereby incorporated by reference.

patent application Ser. No. 10/082,120, filed on Feb. 26, 2002, in the names of Shogo Kosuge and Takahiro Shimizu and entitled “CRITICAL DIMENSION MEASUREMENT METHOD AND APPARATUS CAPABLE OF MEASUREMENT BELOW THE RESOLUTION OF AN OPTICAL MICROSCOPE”, the disclosure of which is hereby incorporated by reference.

### BACKGROUND OF THE INVENTION

The present invention relates to a high precision size measuring apparatus used in a process of manufacturing semiconductor wafers or the like, for measuring and examining a degree of accuracy in alignment of a semiconductor.

High precision size measuring apparatuses include an alignment accuracy measuring apparatus and an alignment measuring apparatus.

First, explanation will be made of measurement for a degree of alignment accuracy as to, for example, a semiconductor wafer as an object to be measured.

FIG. 1 is a typical semiconductor wafer (which will be hereinbelow referred to as wafer). It is noted that this figure is adapted to facilitate the understanding of the configuration of the wafer and is not to scale.

A process of forming a multiplicity of integrated circuit patterns one by one on the wafer, will be first explained. In the figure, the wafer 47 having a diameter of, for example, 150 mm and made of a single-crystal substrate such as Si is formed on its front surface with fine integrated circuit patterns (which will be referred to as IC patterns). An orientation flat 48 is obtained by notching the wafer 47 at one side of its circle, for clearly indicating a crystal orientation of the wafer 47 and for determining a position in a direction of a rotary axis (θ) of the wafer 47. A plurality of IC patterns 50 are formed on the wafer 47. For example, one rectangular portion having a size of, for example, 1 mm×20 mm, shown in FIG. 1, represents one of the IC patterns 50. The IC patterns 50 are formed one by one through steps of projection and exposure with the use of lithography, in the case of FIG. 1, and thereafter, with the repetition of post-process steps of doping and diffusion of impurities and the like. A plurality of alignment marks 49 are usually formed on the wafer 47 for determining positions of the IC patterns 50 in directions of x, y and θ on the wafer during exposure. Of the plurality of alignment marks 49, two alignment marks having the furthest possible distance therebetween are used for correction of positional coordinates in the directions x, y and θ. The length of the alignment marks is, for example, 300 μm. The distances between the alignment marks and the orientation flat 48 are different from each other with a deviation of, for example, about 1 mm, depending upon a particular wafer to be used. Therefore the aliment marks are first detected and then the wafer 47 is positioned at a precise position on the measuring apparatus, which is called a wafer alignment.

Next, after the wafer 47 is precisely positioned on the measuring apparatus, IC chips are formed on the wafer 47. More particularly, exposure for forming chips is first carried out such that each of the IC patterns 50 is formed at a position having a relative distance with respect to the position of the alignment mark 49 which serves as a reference position. Accordingly, the positional coordinates of the alignment mark 49 are obtained, and a relative position with respect to the coordinates x, y, θ of the measuring apparatus is calculated, and the exposure of the IC patterns are then carried out after positional correction is made.

The plurality of IC patterns 50 formed on the wafer as stated above are separated through a scribing process carried out thereafter so as to obtain individual IC chips. In order to cut off individual IC chips from the wafer on which they are formed, through the scribing, a degree of unevenness in the positions of the IC patterns in a row with respect to an alignment mark as a reference must be not greater than a predetermined value (for example, 10 μm). This is because, in the case where the unevenness in the alignment of ICs is greater than 10 μm in a row in the scribing direction, a part of one IC pattern would be cut away by scribing, making the IC chip defective. For these reasons, prior to cutting off the individual IC patterns, alignment marks are detected and measurements of the degree of unevenness in the positions of the IC patterns with respect to the alignment marks, that is, a degree of alignment accuracy, are measured to determine if the unevenness is within the predetermined range so as to help improve the manufacturing process for ICs and increase the yield thereof. Further, in particular, measurements of distances with a high degree of accuracy is required for the measurements of the degree of alignment accuracy.

### SUMMARY OF THE INVENTION

In the process of developing the present invention, the inventors studied the possibility of using a single microscope as an alignment measuring apparatus for positioning the wafer 47 and also as an alignment accuracy measuring apparatus for measuring the alignment of IC patterns 50 such that objective lenses having magnifications different from each other are prepared, one for detection of a degree of alignment accuracy, that is, detection of a degree of unevenness in alignment of semiconductor elements such as IC patterns on the semiconductor wafer, and one for detection of alignment, that is, detection of a deviation of a set position of a semiconductor wafer, wherein the objective lens of the single microscope is changed therebetween at the time of each measurement with the hopes of using a single microscope for both purposes. The reason why the objective lenses having different magnifications are used, is such that the sizes of objects to be measured are greatly different from each other, that is, one of the objects to be measured is a semiconductor element having a size of, for example 1 mm×20 mm or smaller, as stated above, while the other of the objects to be measured is the alignment mark as a reference set on the wafer itself, having a size of, for example, 300 μm.

In the case of using a single microscope for both detections or measurements, the measurements and alignments (positioning) would be carried out as follows:

First, detection of alignment marks and positioning or alignment are carried out as follows:

1. the wafer 47 as an object to be measured is positioned on an to-be-measured object carrying table (mounting table or bed) with the use of the orientation flat 48;

2. a lens having a low magnification (for example, a magnification of 5×) is used as the objective lens of the microscope, and an actual position (X₁, Y₁) of a left side alignment mark 49 is compared with a design position (X₀, Y₀) (at this time, the visual field of the microscope, that is, the display range of an image display device which is not shown is, for example, 1 mm and the design position (X₀, Y₀) is the reference position of the mounting table, such as the origin of the coordinate axis);

3. measurements are carried out with respect to the actual position (X₂, Y₂) of a right side alignment mark in a similar manner to that stated in 2. above;

4. a gradient (θ) of the wafer 47 is calculated from 2. and 3. above; and

5. relative positions of the calculated (X1, Y1) and (X2, Y2) with respect to the (X0, Y0) of the measuring apparatus are calculated so as to correct the displacement from a preset position.

Next, the optical system is replaced with that having a higher magnification (for example, an zoptical magnification of 250×), and the optical axis thereof is adjusted to coincide with that of the new optical system, and the detection (alignment accuracy) of semiconductor elements is then carried out as follows:

1. the wafer 47 is moved so as to align the position of the forehand IC pattern with the optical axis (at this time, the visual field of the microscope, that is, the display range of the image display device which is not shown is, for example, 20 μm);

2. the distance of the position of the forehand IC pattern on Y-axis is measured;

3. the wafer is moved up to a position of a next IC pattern in the X direction, and the distance of the position of the next pattern on Y-axis is measured;

4. with the repetition of the process step in 3. above, distances of positions of patterns on Y-axis are obtained; and

5. whether the wafer 47 is good or bad is determined in light of the unevenness among the thus obtained positions of the patterns.

The criterion with which whether the wafer is good or bad is determined is such that the wafer is determined to be good if an absolute value of a degree of unevenness on Y-axis among all IC patterns is not greater than 5 nm, but it is determined to be defective or bad if there is present an IC pattern having the absolute value greater than 5 nm.

Next, explanation will be made of problems caused in the case of measurements of the alignment accuracy with the use of one and the same microscope as mentioned above with reference to FIG. 2 which shows a configuration of an alignment accuracy measuring apparatus in the case of using a single microscope in both purposes.

Referring to FIG. 2, there are shown a object 1 to be measured, a microscope unit 2, a microscope support portion 3, an axis 4 of a light source for supplying a light beam for illuminating the object 1 to be measured during measurements, that is, the optical axis center of the microscope unit 2, an aluminum support column 5 for supporting the microscope unit 2, the center axis 500 of the support column 5, a stone level block 6 for supporting the support column 5, a distance 7 between the center axis 500 of the support column 5 and the optical axis 4, and a holding portion 8 for the object 1 to be measured. As to the support of the microscope unit 2, there is used such a cantilever type that the microscope support portion 3 which is one end part of the microscope unit 2 is supported by the aluminum support column 5.

In the case of the configuration of the alignment accuracy measuring apparatus shown in FIG. 2, since the distance between the center axis 500 of the support column 5 and the optical axis center 4 of the microscope unit 2 is large (for example, 200 mm), and since the support column 5 is made of aluminum having a high thermal explanation coefficient of 23.7 ppm/deg.C., there would be caused a serious problem such that the thermal displacement error becomes relatively large, that is, about 240 nm for the temperature change of 0.05 deg. C.

Next, explanation will be made of the holding portion 8 for the object to be measured, with reference to FIG. 3 which shows an example of another configuration of an alignment measuring apparatus. This configuration was also devised and studied by the inventors in the present application, through the development to the present invention.

Referring to FIG. 3, there are shown a mounting bed or table 10 for carrying thereon and fixing thereto the object 1 to be measured, a θ rotary mechanism 11 for rotating the object 1 to be measured and the mounting bed 10 in a horizontal direction for positioning (alignment) purpose, and a length measuring device 12 for measuring the degree of straightness for moving the object to be measured with respect to the microscope during measurements of alignment accuracy. In order to measure the degree of unevenness in alignment of semiconductor elements in each of rows on, for example, a wafer as the object to be measured, it is necessary to measure distances of the semiconductor elements on the wafer, on Y-axis while the mounting bed on which the wafer is carried, is moved along X-axis. During the movement, it is ideal that the mounting bed with the object to be measured carried thereon move straightly, but in actuality it moves with wagging or wobbling more or less. Thus, such wagging or wobbling is corrected with the use of the length measuring device 12.

Next, explanation will be made of a method of measuring the degree of alignment accuracy with reference to FIG. 4 which is an enlarged view illustrating an array of semiconductor elements (IC patterns) on the semiconductor wafer 47 (which will be referred to as a wafer).

In the figure, there are shown semiconductor elements 20 on the wafer, alignment marks 21 which indicate reference points for the wafer and layout dimensions of the semiconductor elements on the wafer (note however that the alignment marks, in actuality, do not appear within the visual field as they are extremely large), and X-axis 22 and Y-axis 23 in the transverse directions on the configuration of the semiconductor elements on the wafer. The wafer is moved relative to the microscope in the X-direction while each of the semiconductor elements is enlarged by the microscope, and a minimum and a maximum positional difference ΔY on Y-axis, among differences at the positions To to Tn of the semiconductor elements 20 on an image picked up by a CCD camera. That is, the wafer is moved to respective positions Tn (n=0, 1, 2, . . . , n) on X-axis, and, is magnified by the microscope and is picked up by the CCD camera. Center positions of the semiconductor elements having predetermined sizes are obtained at respective positions T0 to Tn in the picked-up image through image processing and distances of the respective center positions on the Y-axis are derived so as to calculate ΔY which is the difference between the maximum and the minimum of the derived distances.

From the results of studies made by the inventors, it has been found that the reproducibility (3σ) of measurement for the thus obtained alignment accuracy is relatively large, that is, several ten nm, and the reproducibility is less accurate than several nm required for post-process steps (in particular, scribing step) after fabrication of the wafer. The reproducibility (3σ) of measurement exhibits a deviation on a statistical calculation, and if 3σ is several ten nm, it means that 99.7% of all data comes into a range of several ten nm.

The result of the studies made by the inventors has revealed the reason why the required reproducibility of measurements cannot be obtained by the method in which the positions of the alignment marks and the semiconductor elements are detected with the use of a single microscope in which objective lenses are replaced with each other. That is, although the measurements of alignment accuracy are carried out with the use of a thermostat oven in which variation in the temperature of the measuring apparatus is restrained to about ±1 deg. C. in its entirety, it takes about 60 seconds to measure alignment accuracy for all semiconductor elements in one row on the wafer. The inventors found that the accuracy of measurements deteriorate due to variation in the environmental temperature within 60 seconds.

In other words, in order to attain a desired object, that is, 3σ=several nm, with the provision of such a configuration that a predetermined degree of accuracy of measurements can be maintained in at least 60 seconds, measurements of alignment accuracy with satisfactory reproducibility can be made. In order to obtain such a configuration, it is required to eliminate or restrain displacements of an object to be measured during measurement of alignment accuracy, including thermal displacements and aging or secular displacements of components constituting the alignment accuracy measuring apparatus.

An object of the present invention is to provide a high precision size measuring apparatus, which can satisfy the above-mentioned requirements.

To this end, according to the present invention, there is provided a high precision size measurement apparatus comprising:

at least one first optical microscope with a low measurement magnification and at least one second optical microscope with a high measurement magnification for measuring a size of an object;

a holding portion for holding said object to be measured;

a moving mechanism for moving said holding portion for said object to be measured within visual fields of said first and second optical microscopes;

a first and a second image pickup devices for picking up an optical image of said object through said first and second optical microscopes;

a signal processing unit for processing video signals obtained from said first and second image pickup devices; and

a control unit for controlling said moving mechanism, wherein, based on positional coordinates of said object measured by said first optical microscope, positional coordinates of said object to be measured by said second optical microscope is calculated.

The principle of the present invention will be explained with reference to FIG. 5 which shows a concept of an alignment accuracy measuring apparatus according to the present invention.

In the present invention, there are provided a microscope 100 for alignment detection and a microscope 102 for measurements of alignment accuracy which are independent from each other, and an object to be measured such as a semiconductor wafer (which will be hereinbelow referred to as wafer) is set on a common movable bed 104. That is, at first, the movable bed is moved so that the wafer 101 is positioned below the microscope 100 for detection of alignment marks, and positions of two alignment marks 49 are detected through the method described above. The microscope 100 for detection of alignment marks may have a low optical magnification (for example, 5×) since the alignment marks are relatively large (for example, 300 μm), and accordingly, no serious problems are caused in particular by temperature variation. From the detected positions of the two alignment marks 49, the positional coordinates (x, y) and the angular deviation or displacement θ of the wafer are obtained and are corrected so as to coincide with the reference point (X₀, Y₀) which is described above. Then, the movable bed 104 is moved along X-axis so that the wafer 47 comes below the alignment accuracy measuring microscope to measure the degree of alignment accuracy. Since the microscope 102 for measurements of alignment accuracy has a high optical magnification, for example, 250×, it is necessary to remove thermal displacement and aging or secular change of the microscope itself and components thereof as well during measurements of alignment accuracy with respect to temperature variations or to reduce thereof as much as possible in order to attain the desired object, that is, 3σ=several nm. For these reasons, the microscope 102 exclusively for measurements of alignment accuracy is provided independently. It becomes possible to independently provide the dedicated alignment accuracy measuring microscope 102 and arrange the microscope 102 in a configuration which has the smallest possible thermal and aging displacement.

FIG. 5(a) shows a cross-section taken along a-a. As shown in FIG. 5(a), the microscope 102 for alignment accuracy measurement is fixed to a fixing portion 112. And, the optical axis 103 (that is, the center of the microscope body) of the microscope 102 for alignment accuracy measurement is coincident with the center of the fixing portion 112 for this microscope. The fixing portion 112 is secured to a stone top panel 106 with a plurality of bolts 108 which are provided axis-symmetrically about the optical axis of the microscope 102 for measurements of alignment accuracy. That is, the fixing portion 112 is secured in axial symmetry. In this way, since the microscope 102 is secured in axial symmetry, the microscope 102 is configured such that the optical axis thereof hardly changes against a certain extent of thermal displacement and aging or secular change. Note that, in FIG. 5, 105 denotes an aperture for light transmission and 109 denotes a prism. The aperture 105 may be of circular shape as shown in FIG. 5 or any other shapes that are symmetric about the X-axis or Y-axis of the aperture.

Further, in an embodiment, support columns 119 for supporting the stone top panel 106 with the stone level block are made of granite. This granite has a thermal coefficient of about 9.10 ppm/deg. C, and accordingly, its thermal displacement error is about 90 nm which is small in comparison with such a configuration that the support columns are made of aluminum.

Further, in an embodiment, the connection between the microscope 102 for measurements of alignment accuracy and an illuminating portion 110 is made physically noncontact with each other, that is, the illuminating portion 110 upon which light transmitted from a light source which is not shown through a plurality of optical fibers which are not shown, is not made in physical contact with the microscope 102, and accordingly, heat is prevented from being transmitted from the illuminating portion 110 to the microscope 102 body. It is noted that in order to eliminate affection by external light, the microscope 102 is provided with a cylindrical projecting portion 107 having an inner diameter which is larger than that of the cylindrical illuminating portion 110 so as to have a telescopic configuration.

In an embodiment, the object to be measured is placed on the mounting bed after completion of the correction of the detected alignment position (namely, correction of X, Y and θ). This makes it unnecessary to rotate the object to be measured on the mounting bed, which in turn makes it possible to realize an integral configuration of the mounting bed and a moving means, thereby reducing errors during correction of a degree of straightness.

Other objects, features and advantages of the invention will become apparent from the following description of the embodiments of the invention taken in conjunction with the accompanying drawings.

### BRIEF DESCRIPTION OF THE DRAWINGS

FIG. 1 is a view illustrating a semiconductor wafer as an example of an object to be measured;

FIG. 2 is a view illustrating a cantilever structure for attachment of a microscope, which was studied by the inventors during the development of the present invention;

FIG. 3 is a view illustrating a holding device for holding an object to be measured, which was studied by the inventors during the development of the present invention;

FIG. 4 is a view illustrating an example of an array of semiconductor elements on a semiconductor wafer;

FIG. 5 is a view illustrating an alignment accuracy measuring apparatus for explaining the principle of the present invention;

FIG. 6A is a partially broken-away front view illustrating an alignment accuracy measuring apparatus in an embodiment of the present invention;

FIG. 6B is a partially broken-away side view illustrating the alignment accuracy measuring apparatus shown in FIG. 6A;

FIG. 7 is a view for explaining a object holding portion in the alignment accuracy measuring apparatus shown in FIGS. 6A and 6B in more detail;

FIG. 8 is a view for illustrating the entire alignment accuracy measuring apparatus including an electrically processing portion in the embodiment of the present invention;

FIG. 9 is a sidewise sectional view illustrating a Z-axial fine adjustment mechanism;

FIG. 10 is a side view illustrating the Z-axial fine adjustment mechanism;

FIG. 11 is a plan view illustrating the Z-axial fine adjustment mechanism; and

FIG. 12 is a bottom view illustrating the Z-axial fine adjustment mechanism.

### DESCRIPTION OF THE EMBODIMENTS

Explanation will be hereinbelow made of an embodiment of the present invention with reference to the accompanying drawings through which like reference numerals are used to denote like parts.

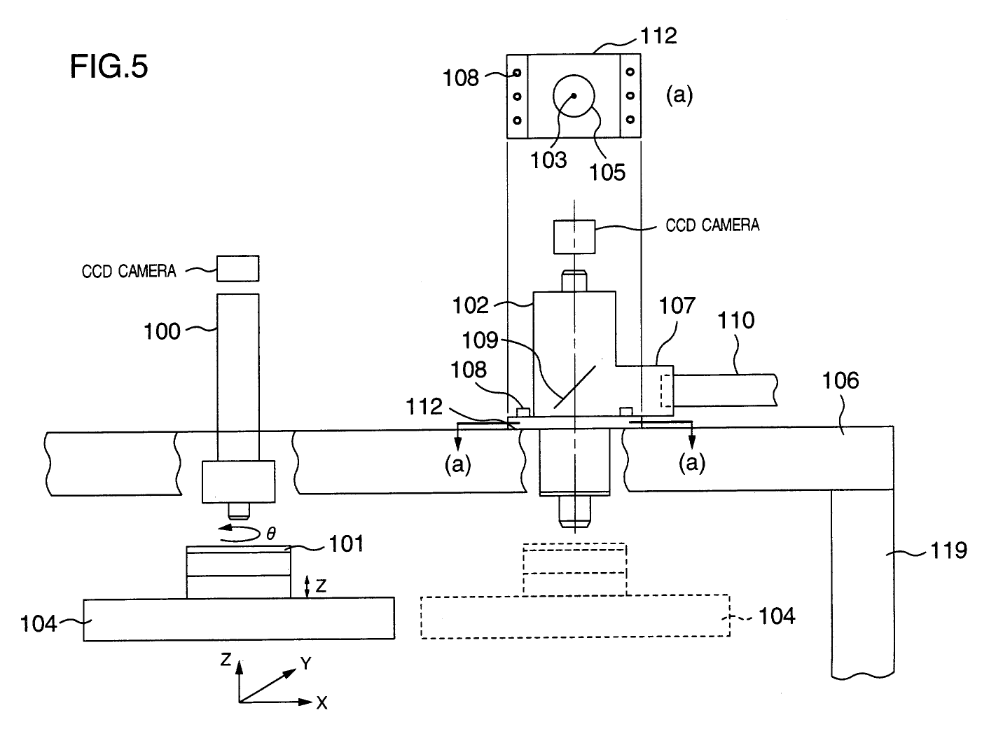

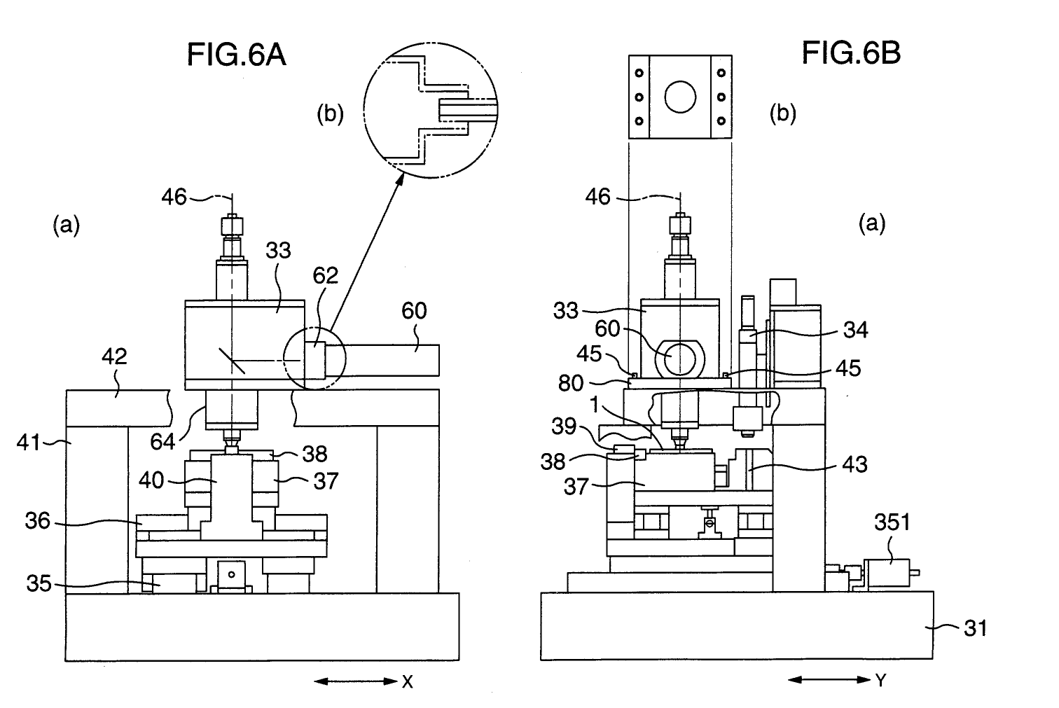

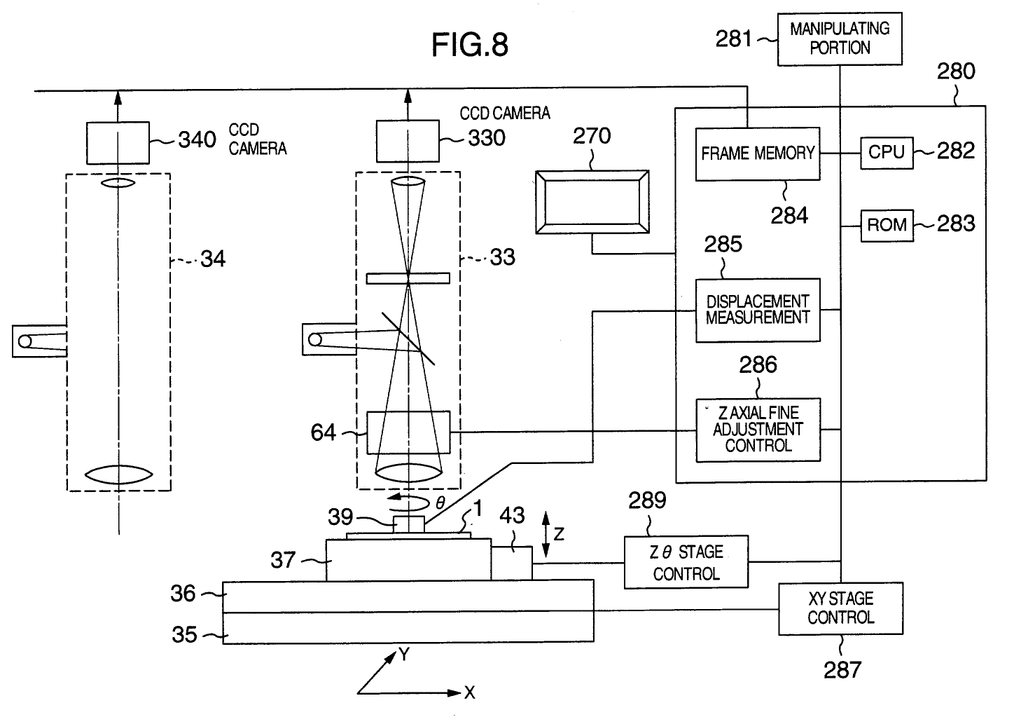

FIGS. 6A and 6B are a partially broken-away front view illustrating an alignment measuring apparatus in an embodiment of the present invention, and a partially broken-away side view including a partial elevation view. This apparatus is adapted for checking alignment accuracy for semiconductor elements such as IC patterns on a semiconductor wafer or the like although it should not be limited thereto. As indicated by (a) in FIG. 6A and (a) in FIG. 6B, there is provided on a level block 31 a moving mechanism for positioning an object 1 to be measured at a position on the optical axis of a microscope 34 for detection of alignment, and then positioning the same at a position on the optical axis of a microscope 33 for measurement of alignment accuracy. That is, a Y-stage 35 is arranged on the level block 31, and an X-stage 36 is arranged on the Y-stage 35 which is driven by a Y-stage drive motor 351 so as to be moved in left and right directions in FIG. 6B. The X-stage 36 is driven by a X-stage drive motor which is not shown so as to be moved left and right directions in FIG. 6A. Further, an adsorbing or suction panel (mounting bed) 37 for holding the object 1 to be measured is arranged on the X-stage 36. The correction of the degree of straightness during movement of the X-stage 36 is carried out in such a way that the a distance from a reference point on the adsorbing panel 37 on which the object 1 to be measured is secured, to a straight bar 38 is measured with the use of a displacement meter (length measuring device) 39 on a displacement meter base 40. The straight bar 38 has a flatness of about λ/20 or so, and accordingly, the measured value should be corrected according to a position of the X-stage. This correction process is made by a processing unit 280 (refer to FIG. 8), which will be explained later, for processing a signal from the displacement meter 39. The microscope 33 for measurement of alignment accuracy and the microscope 34 for detection of alignment are held on the stone top panel 42 supported at the tops of four stone support columns 41 which are planted upright on the level bock 31. In this embodiment, the distance between the optical axis of the microscope 33 for alignment accuracy measurement and the optical axis of the microscope 34 for alignment detection is 75 mm. Referring to FIGS. 6A and 6B, there is shown an illuminating portion 60 composed of a plurality of optical fibers, for introducing light from a light source which is not shown, into the microscopes so as to illuminate the object 1 to be measured. (b) in FIG. 6A is a sectional view illustrating a coupling part (projecting portion 107 in FIG. 5) between the illuminating portion 60 and the microscope 33 for measurement of alignment accuracy. As shown, the microscope 33 is provided with a cylindrical projecting portion 62 for receiving the optical fibers in a lens barrel portion of the microscope 33, and the inner diameter of the projecting portion 62 is greater than that of the illuminating portion 60 so as to be made into physical noncontact with the illuminating portion 60, that is, the so-called telescopic configuration is formed. With this configuration, heat is prevented from being directly transmitted from the illuminating portion 60 from the microscope 33.

A partial elevation view (b) in FIG. 6B shows a method of fixing the microscope 33 for measurement of alignment accuracy onto the stone top panel 42. The microscope 33 for measurement of alignment accuracy is fixed to the stone top panel 42 by fastening a fixing part or a pedestal 80 of the microscope to the stone top panel 42 with six fixing bolts 45. These six fixing bolts 45 are arranged in axial symmetric or symmetrical at righ and left with respect to the optical axis 46. With the arrangement, even if a displacement of the microscope 33 for measurement of alignment accuracy occurs due to a heat, the displacement is caused in a laterally homogenous or uniform manner in axial symmetric or symmetrically at right and left about the optical axis 46, and as a result, no deviation of the optical axis 46 occurs.

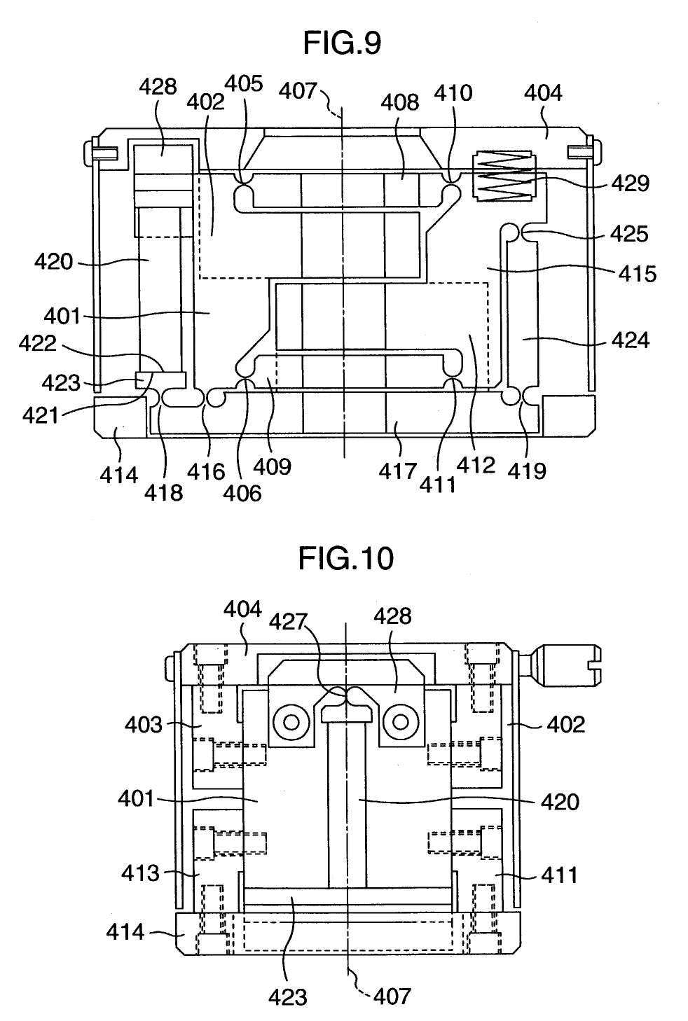

Reference numeral 64 denotes a Z-axial fine adjustment mechanism for automatically focusing the microscope 34, for which the one disclosed in, for example, JP-A-298289/00 or the like having a performance equivalent to or higher than that of the former may be used. The Z-axial fine adjustment mechanism 64 will be hereinbelow explained with reference to FIGS. 9 to 12.

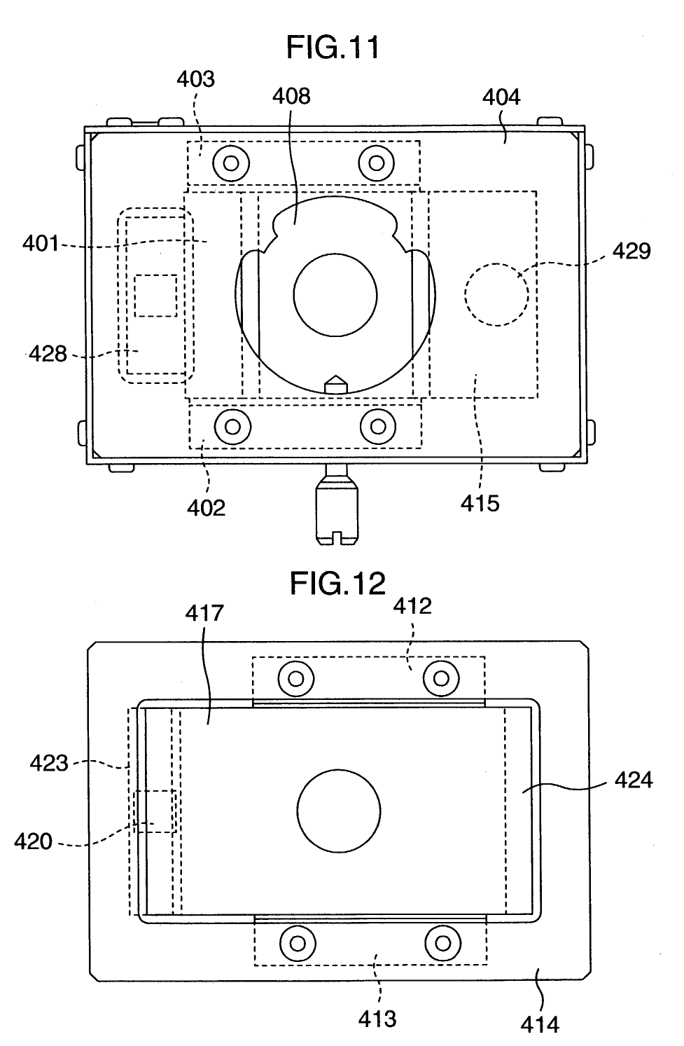

FIG. 9 is a sidewise sectional view illustrating the mechanism 64, FIG. 10 is a front view illustrating the mechanism shown in FIG. 9, FIG. 11 is a plan view illustrating the mechanism shown in FIG. 9 and FIG. 12 is a bottom view illustrating the mechanism shown in FIG. 9. A base 401 is fixed to an upper plate 404 which is attached to a lens barrel which is not shown, through the intermediary of coupling plates 402, 403. The base 401 is provided thereto at its upper and lower parts with resilient hinges 405, 406 which are formed by arcuate cut in a vertical direction and which are arranged in parallel with an optical axis 407. On the extensions of the resilient hinges 405, 406, there are provided parallel links 408, 409 extended in a direction perpendicular to the optical axis 407, having their end parts which are provided with a movable block 415 fixed to a lower plate 414 which is attached thereto with an objective lend block which is not shown, through the intermediary of coupling plates 412, 413. Further, a resilient hinge 416 horizontally notched is provided at the lower end of the base 401, and a horizontal arm 417 is provided at the extension thereof while a resilient hinge 413 horizontally notched is provided at a side end part of the base. Further, a resilient block 19 horizontally notched is provided on the movable block side. The resilient hinges 416, 418, 419 are arranged in one and the same plane orthogonal to the optical axis 407. The resilient hinge 108 is formed in its upper part with a piezoelectric element abutting block 423 having a piezoelectric element abutting surface 422, which makes contact with the lower surface 412 of the a piezoelectric element 420. Further, the resilient block 419 is formed in its continuous part with a coupling block 424, and its upper end part is formed with a resilient hinge 419 so as to couple the horizontal arm 417 with the movable block 415. The piezoelectric element 420 is provided with a piezoelectric element support block 428 having a resilient hinge 427 formed by cutting in a direction crossing the resilient hinge 418 at a right angle thereto, and fixed to the base 401. A compression spring 429 is interposed between the movable block 415 and the upper plate 404, being compressed therebetween. The operation thereof is such that when the movable block 415 is depressed down from the upper plate 404 by a repulsion force of the compression spring 429, the horizontal arm 417 is to be depressed down, relative to the base 401, through the intermediary of the movable block 415 and the coupling block 424 since the upper plate 404 is fixed to the base 1 through the intermediary of the coupling plates 402, 403. The horizontal arm 417 is depressed downward through the intermediary of the resilient hinge 419 so as to clockwise turn around the resilient hinge 419 as a fulcrum, and accordingly, the piezoelectric element 420 is pressed through the intermediary of the resilient hinge 418 and the piezoelectric element abutting block 423. The piezoelectric element 420 is held between the piezoelectric element support block 428 and the piezoelectric element abutting block 423, being interposed and compressed therebetween. In this condition, a voltage is applied to the piezoelectric element 420 under control by a control device which is not shown. When the piezoelectric element is stretched, the horizontal arm 417 is pressed through the intermediary of the piezoelectric element abutting block 423 and the resilient hinge 418, and accordingly, the horizontal arm 417 turns counterclockwise about the resilient hinge 416 as a fulcrum. As a result, the movable bock 415 is pushed up by means of a coupling rod 424. The movable block 415 is upwardly displaced being guided by the resilient hinges 405, 406, 410, 411 and the parallel links 408, 409. Thus, the movable block 415 displaces an objective lens upward through the intermediary of the coupling plates 412, 413, and the lower plate 414. At this time, the horizontal arm 417 serves as a lever bar around the resilient hinge 416 as a fulcrum, and since the distance between the resilient hinges 405, 410 is different from those between the resilient hinges 406, 411 and between the resilient hinge 405, 410, the horizontal position of the resilient hinge 419 and the value of a horizontal displacement of the resilient hinges 410, 411 do not correspond to each other, and further, an inclination of the horizontal arm 417 and that of the parallel links 409, 408 are also different from each other. However, with the provision of the resilient hinges 419, 428 and the coupling block 424 between the horizontal arm 417 and the movable block 415, the coupling block 424 is inclined so that a positional deviation in a horizontal direction between the horizontal arm 417 and the movable block 415 is absorbed. Accordingly, a slight entanglement caused by a positional deviation is prevented from occurring, and accordingly, a severe parallel displacement of the movable block 415 can be materialized, thereby it is possible to enhance the reproducibility of straightness. Further, although the upper end surface and the lower end surface of the piezoelectric element 420 can not be set to be completely parallel with each other, the resilient hinges 418, 427 can be inclined, depending upon deviations of the upper and lower end surfaces of the piezoelectric element 420 from the parallelism, that is, the inclination since they cross each other at a right angle, and accordingly, the piezoelectric element abutting surface 422, 426 can follow along the upper and lower end surfaces of the piezoelectric element 420. Thus, no entangling force is caused between the base 401 and the horizontal arm 417, and accordingly, no factor deteriorating the reproducibility of straightness is caused. In this embodiment, the length of the arms of the parallel links 408, 409 are set to 50 mm, and a minimum wall thickness of the resilient hinges to 0.5 mm. The base 401, the parallel links 408, 409, the horizontal arm 417 and the like are formed from carbon steel having a thickness of 40 mm by integral cutting in a wire cut process. The degree of straightness thereof can be not greater than 0.003 μm with respect to the vertical displacement 100 μm, and the reproducibility of straightness can be not greater than 0.002 μm.

With only such a configuration as stated above, in which the piezoelectric element drive mechanism and the resilient fulcrum lever rod mechanism are coupled in the lower part of the resilient fulcrum four node link mechanism, and a resilient fulcrum crossing the piezoelectric element abutting portion at a right angle, is added, a Z-axial fine adjustment mechanism for a microscope, having a reproducibility of straightness with an order of 1 nm can be materialized.

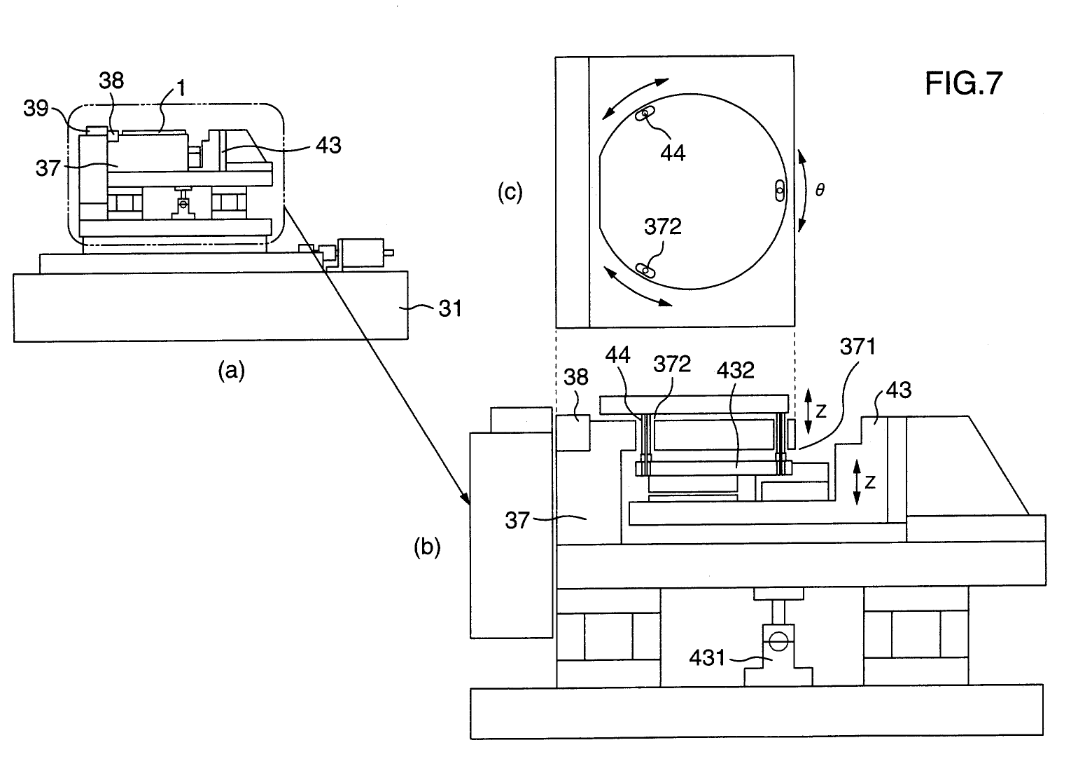

Next, referring to FIGS. 7 and 8, explanation will be made of the configuration of the embodiment in relation to an alignment method.

FIG. 7(a) is a sectional view picked up from the FIG. 6B and illustrating a part relating to the alignment, FIG. 7(b) shows a detailed sectional view illustrating a part surrounded by a one-dot chain line in FIG. 7(a), and FIG. 7(c) is a view illustrating the semiconductor wafer 1 as an object to be measured, set on the adsorbing or suction panel (mounting bed) 37.

An object 32 to be measured is set on the adsorbing panel 37 through handling manually by a person or automatically by a handling robot which is not shown. The adsorbing panel 37 has a recessed structure having a recess 371 in which a θ stage 43 is inserted. The θ stage 43 is moved both in the Z (vertical) direction and in the θ direction (rotation in the x-y plane) by a Zθ stage drive portion 431. The Zθ stage 43 has a movable part 432 provided therein with three lift pins 44 which are moved in the Z direction and are rotated in the θ direction. Further, the adsorbing panel 37 is formed therein with three holes 372 for preventing the lift pins 44 from impinging upon the adsorbing panel 37. The lift pins 44 are hollow, and accordingly, the insides of the lift pins 44 can be evacuated by a vacuum pump which is not shown in order to prevent the wafer 32 from slipping on the lift pins 44 when the Zθ stage 43 is moved. The X-stage 36 and the Y-stage 35 are moved so as to position the wafer below microscope 34 for detection of alignment, and after the Zθ stage 43 is raised, a position of the wafer on the x-y plane and an angular deviation or displacement (rotation in the θ direction) are measured so as to obtain coordinates (x, y) and the angular deviation θ. Then, the lift pins 44 are θ-rotated so as to adjust the position of the wafer in the θ direction. Thereafter, the lift pins 44 are lowered so as to set the wafer on the adsorbing panel 37. The adsorbing plate 37 is provided with an adsorbing mechanism (which is not shown) for preventing the wafer 32 from slipping when the X-stage 36 and the Y-stage 35 are moved. The measured positional coordinates (x, y) of the wafer 32 is taken into a processing unit 280 shown in FIG. 8 for correction with respect to positional coordinates of the measuring system.

It is noted that since the adsorbing panel 37 and the straight bar 38 are made of low expansion materials, and have an integral structure, either one of them does never cause a large thermal dislocation due to thermal expansion. Thus, it is possible to correct a degree of straightness with a high degree of accuracy.

Through the above-mentioned operation, the alignment of the wafer 32 as the object to be measured has been completed.

Next, the X-stage is moved while the wafer 32 is still fixed on the adsorbing plate 37 so as to position the wafer 32 below the microscope 33 for measurement of alignment accuracy in order to carry out measurement of alignment accuracy.

The above-mentioned movement is made in such a way that the X-stage drive motor is rotated by a XY stage control portion 287 through manipulation of a manipulating portion 281. Explanation will be hereinbelow made of the measurements of alignment accuracy.

At first, the following steps are taken before the measurement of alignment accuracy, in order to adjust the optical axis.

Correction of the wafer 32 in the θ direction is carried out as follows:

After completion of positioning in the X and Y directions, the lift pins 44 are raised so as to lift the wafer 32 upward in the Z direction from the adsorbing panel 37. As stated above, since the lift pins 44 are hollow, it may be considered that the object 1 to be measured is fixed and supported by means of a vacuum chuck. Then, the lift pins 44 are rotated so as to make correction in the θ direction. Thereafter, the lift pins 44 are lowered so as to make the wafer into again contact with the adsorbing panel 37. As stated above, since the adsorbing panel 37 has the adsorbing mechanism which is not shown, the object 1 to be measured is fixed. Thereafter, the fixing of the lift pins 44 by the vacuum chuck is released.

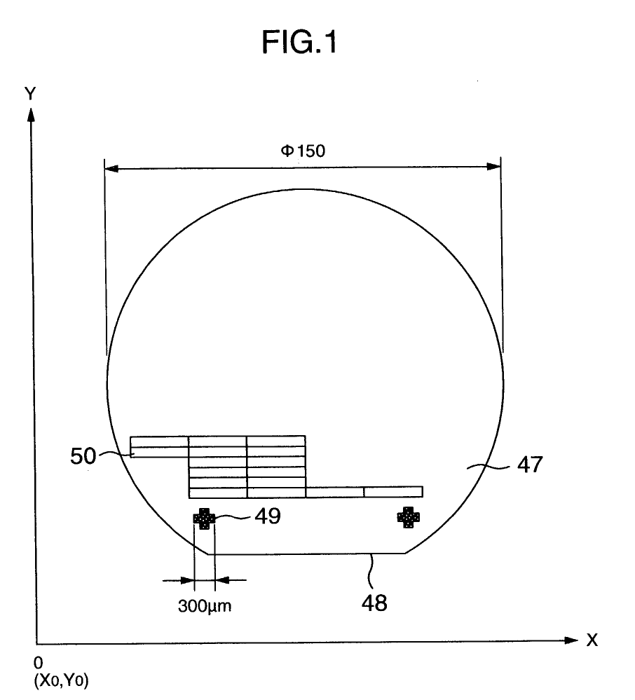

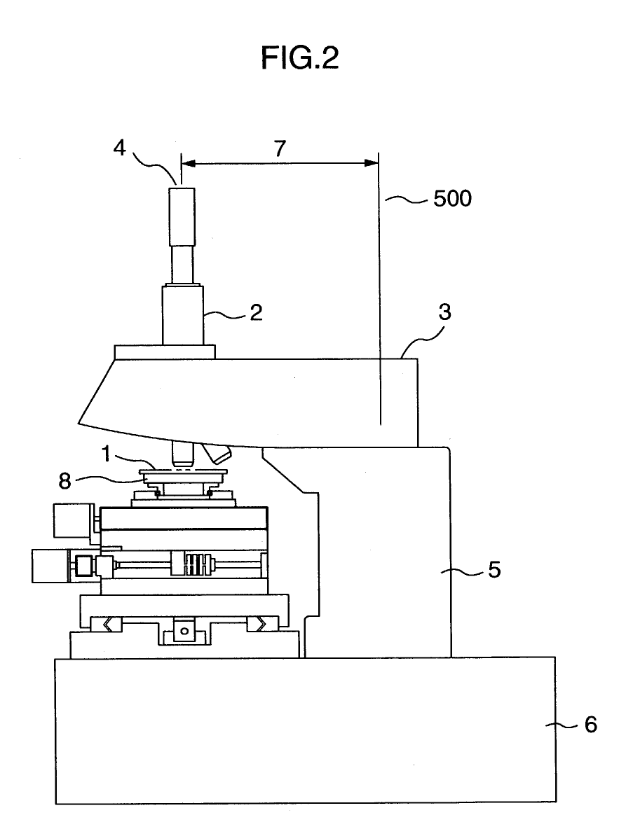

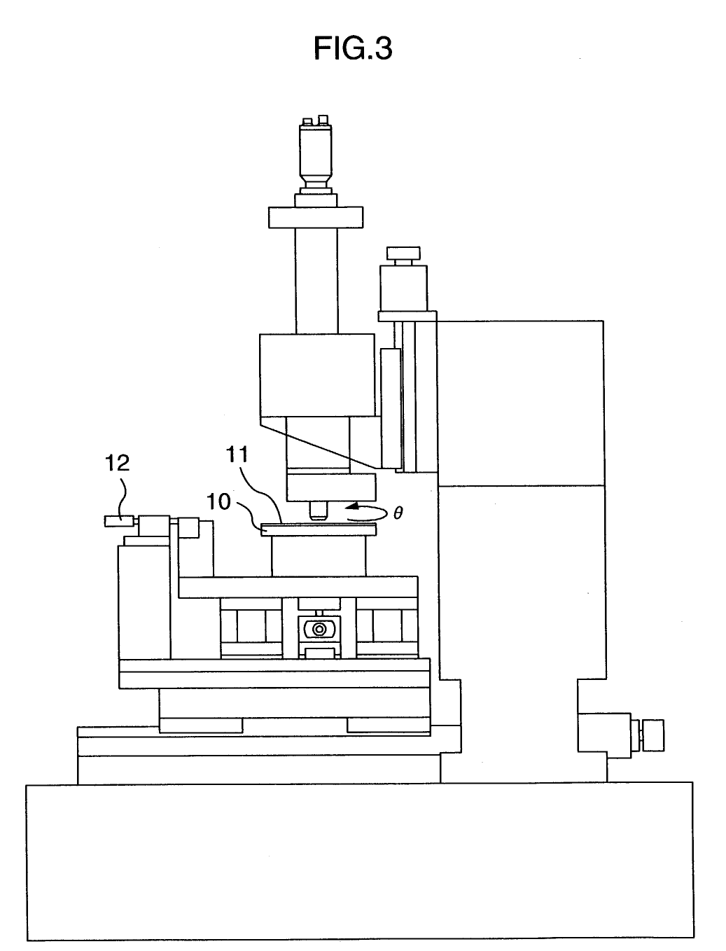

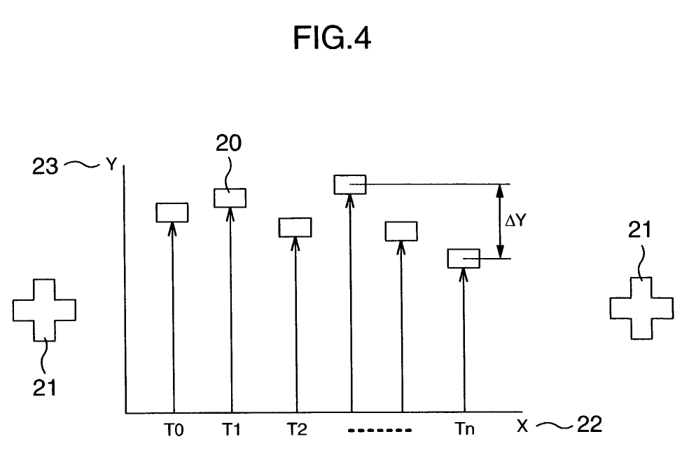

Thereafter, the measurements of alignment accuracy is started in, for example, the method as stated above. That is, referring to FIG. 1, distances of the IC patterns are measured on the Y axis, in the order from the left to the right in each row of the IC patterns, and unevenness in the alignment of the IC patterns is calculated. This is carried out for every row of the IC patterns in the order from the lower side to the upper side of the wafer (as viewed from the orientation flat).

With reference to FIG. 8 which shows a control circuit for the alignment accuracy measuring apparatus in the above-mentioned embodiment, explanation will be made of the control circuit for the alignment accuracy measuring apparatus.

Referring to FIG. 8, an image of an object (a object to be measured, such as a semiconductor wafer) projected by the microscope 33 for measurement of alignment accuracy or the microscope 34 for detection of alignment is picked up by a CCD camera 340 or 330, and an alignment/alignment accuracy processing unit 280 executes measurement of positions of alignment marks, calculation of coordinates (x, y) and θ of the wafer from the measured data, measurements of semiconductor elements (such as, IC patterns on a wafer) on the object to be measured, calculation of unevenness in alignment from the measured values and the like.

The manipulating portion (man-machine interface unit) 281 is connected to the processing unit 280 which is composed of a CPU 282, a ROM 283, a fame memory 284, a displacement meter portion 285 receiving a signal from a displacement meter 39 and a Z-axial fine adjustment mechanism 286 for controlling a Z-axial fine adjustment mechanism 64 for automatically focusing the microscope 33 for measurement of alignment accuracy. The image picked up by the CCD camera is displayed on a monitor 270 connected to the processing unit 280.

The object to be measured is carried on the adsorbing panel 37 set on the XY stage, and is displaced into the visual field of the microscope 34 or 37. This displacement is carried out under control of a command delivered from the CPU 281 to the XY stage control part 287 by way of an RS-232C line. Further, the displacement of the object to be measured by the Zθ stage 43 in the Z direction and the direction θ(rotation in the x-y plane) is controlled similarly under a command delivered from the CPU 281 to a Zθ stage control portion by way of the R-232C line, by driving a Z-axial drive motor and a θ axial drive motor which are not shown so as to move the adsorbing panel 37 up and down and to rotate the three lift pins 44 onto which the object to be measured is fixed. It is noted that the objective lens in the microscope 33 for measurement of alignment accuracy is finely moved in a vertical direction by the Z-axial slight adjustment mechanism 64 for automatic focusing, so as to be in-focus.

The control method and the configuration of the control circuit can be easily made by those skilled in the art in view of the disclosure of the present application with use of well-known image processing techniques, and accordingly, no further detailed description thereto is required. It is noted that an image processing circuit disclosed in U.S. patent application Ser. No. 10/082,120 filed on Feb. 26, 2002 may be used with some modification.

The present invention can be applied to not only the microscope for alignment accuracy but also any of various kinds of microscopes for precise measurements.

The alignment accuracy measuring apparatus in the above-mentioned embodiment has a high reproducibility (3σ) of measurements, and has extremely excellent measuring accuracy.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A high precision size measurement apparatus comprising:
at least one first optical microscope with a low measurement magnification and at least one second optical microscope with a high measurement magnification for measuring a size of an object;
a holding portion for holding said object to be measured;
a moving mechanism for moving said holding portion for said object to be measured within visual fields of said first and second optical microscopes;
a first and a second image pickup devices for picking up an optical image of said object through said first and second optical microscopes;
a signal processing unit for processing video signals obtained from said first and second image pickup devices; and
a control unit for controlling said moving mechanism,
wherein, based on positional coordinates of said object measured by said first optical microscope, positional coordinates of said object to be measured by said second optical microscope, is calculated.

2. A high precision size measurement apparatus according to claim 1, wherein said first optical microscope is used for alignment of said object and said second optical microscope is used for measurement of patterns formed on said object.

3. A high precision size measurement apparatus according to claim 2, wherein the measurement magnification of said first optical microscope is substantially 5× and the measurement magnification of said second optical microscope is substantially 250×.

4. A high precision size measurement apparatus according to claim 2, further comprising a base board for holding said second optical microscope, wherein said second optical microscope is supported on said base board by a supporting member, and wherein said supporting member is supported on said base board in axial symmetry with respect to an optical axis of said second optical microscope.

5. A high precision size measurement apparatus according to claim 4, wherein said base board and said supporting member are made of stone.

6. A high precision size measurement apparatus according to claim 2, further comprising an illumination light guiding portion and wherein said second optical microscope includes an illumination light introducing portion for receiving an illumination light for illuminating said object to be measured, said illumination light guiding portion and said illumination light introducing portion are coupled to each other in non-contact manner.

7. A high precision size measurement apparatus according to claim 2, wherein said object to be measured is a semiconductor wafer, and wherein said first optical microscope is used for alignment of said semiconductor wafer and said second optical microscope is used for measurement of said semiconductor patterns formed on said semiconductor wafer.
